(19) United States
(12) Patent Application Publication
(10) Pub. No.: US 2022/0240535 A1
(43) Pub. Date: Aug. 4, 2022

(54) Product Containing Cocoa and One or More Sweetening Agents, Method For The Production of Such Products, in Particular Chocolate Products or Chocolate-Like Products, Use of Products of Said Type, For Example To Make Chocolate Products or Chocolate Like Products

(71) Applicants: KOA Switzerland GmbH, Zurich (CH); ETH Zurich, Zurich (CH)

(72) Inventors: Ursina KRAHENMANN, Winterthur (CH); Erich WINDHAB, Hemishofen (CH)

(73) Assignees: KOA Switzerland GmbH, Zurich (CH); ETH Zurich, Zurich (CH)

(21) Appl. No.: 17/622,354

(22) PCT Filed: Jun. 5, 2020
(86) PCT No.: PCT/EP2020/000110

§ 371 Date: Dec. 23, 2021

(30) Foreign Application Priority Data
Jun. 24, 2019 (DE) 102019004355.3

(51) Int. Cl. A23G 1/48; A23G 1/00; A23G 1/36; A23G 1/40; A23G 7/00

(52) U.S. Cl. CPC A23G 1/48; A23G 1/0033; A23G 1/36; A23G 2200/08; A23G 1/005; A23G 7/0093; A23G 2210/00; A23G 1/40

(57) ABSTRACT

The invention relates to products for the production of chocolate products and chocolate-like products, whereby sweetening and/or mass-providing filling substances obtained from the cocoa fruit pulp or also from the placenta and/or the cocoa fruit shell replace, either wholly or in part, the conventional sweetening and mass-providing filling components, in particular sugar, in such products. The invention relates not only to a suitable process for the production of such products, but also to the use of such products.

The invention relates to a product comprising cacao and one or more sweeteners, and also one or more fillers.

The invention additionally relates to a process for producing such a product, especially for producing chocolate products or chocolate analog products.

The invention further relates to the use of such products.

### STATE OF THE ART

Conventional chocolate products contain about 50 wt % of sucrose and about 30 wt % of fat, for example cacao butter and milk fat. According to WHO recommendations, sugar and fat contents in foods should be distinctly reduced for nutritional/health reasons.

The WHO has published a new study which examines why manufacturers use such large amounts of sugar in foods. A publication entitled “Incentives and disincentives for reducing sugar in manufactured foods: An exploratory supply chain analysis” concludes that an approach embracing the whole food system would be needed for reduction of sugar consumption [1].

The background to the WHO report was growing concern in view of the excessive consumption of free sugar in the entire European region. This is held responsible for increasing weight in adults and in children. According to the WHO recommendation, both in adults and in children, less than 10%—ideally less than 5%—of daily energy supply should come from free sugars. Given a calorie density of 1697 kJ/100 g of sugar and an average daily energy consumption of 9155 kJ (guide value), a maximum of 457.75 kJ of sugar and, in the case of consumption of sugar entirely from chocolate, thus a maximum of 54 g of conventional chocolate per day should be consumed.

This is the origin for the crucial interest for the chocolate and confectionery industry in developing for example chocolates of distinctly reduced calorie density and in using natural components for sweetening and as fillers in such products.

The basic definition of chocolate according to Codex Alimentarius and national legislation derived therefrom describes chocolate as a product made from cacao products and types of sugar, containing at least 35% total dry cacao mass, of which at least 18% is cocoa butter and at least 14% is fat-free dry cacao mass.

For milk chocolate, at least 25% total dry cacao mass, at least 14% dry milk mass, from partly or fully dehydrated whole milk, partly or fully skimmed milk, partly or fully dehydrated, cream, partly or fully dehydrated cream, butter or milk fat, at least 2.5% fat-free dry cacao mass and at least 3.5% milk fat must be present, where the total fat content composed of cacao butter and milk fat must be at least 25%.

Further details of the legal basis can be found in Directive 2000/36/EC of the European Parliament and of the Council of Jun. 23, 2000 relating to cocoa and chocolate products intended for human consumption (OJ EC No. L 197 p. 19), which was transposed into German law [2] with the Kakaoverordnung [Cacao Act] of Dec. 15, 2003 (BGB1. I p. 2738), last amended by article 9 of the act of Jul. 5, 2017 (BGB1. I p. 2272).

With regard to the sugars/products made from sugars/types of sugar that are present in chocolate, it can be inferred from the fundamental legal guidelines that up 65% of the chocolate mass may consist thereof. Sugar thus does not on its own fulfill the role of “sweetness generation”, but is an essential dry substance (filler) that contributes to the chocolate mass.

On consumption of chocolate, depending on melting characteristics and dwell time in the mouth, only a small proportion about (≤20-40%) of the sugar present in the chocolate mass is dissolved in saliva and hence reaches the sweetness-perceiving taste sensors on the tongue and gums.

The reason for this is that finely ground sugar (particle size about≤30 micrometers) is incorporated into the continuous fat phase that ensheathes the sugar particles and hence protects them from rapid dissolution in the aqueous saliva phase.

The predominant undissolved residue of the sugar is swallowed by the consumer as solids suspended in the molten fat phase in the form of fine particles. Thus, conventional chocolate products have both a high calorie density and a high potential to promote the development of insulin resistance (metabolic syndrome) if such products are consumed in a relatively large amount or regularly.

Already known from WO 2007/025756 A1 is a low-fat confectionery product consisting of a water-in-oil emulsion with at least a 60% by weight water phase component and a maximum 20% by weight fat component, in which the water-in-oil emulsion includes chocolate particles and at least one structuring component. Polysaccharides (specifically carrageenan) and/or proteins are addressed as the latter.

Thickening and/or sweetening substances from the cacao fruit are not mentioned. Fibers and their advantageous nutritional properties are likewise not included (not even generally). Nor is any consideration given to the use of fruit juice concentrates and the use of thickening/gelating additives (carrageenan here) which is thus obsolete.

WO 2014/118489 discloses particle-stabilized food compositions based on w/o and o/w emulsion systems and a process for production thereof, which are used for production of reduced-calorie chocolate systems. One disperse water phase mentioned is the use of fruit juices.

Thickening and/or sweetening components from the cacao fruit are not mentioned. Fibers and their advantageous nutritional properties are likewise not included, not generally. There is likewise no mention of the use of fruit juice concentrates.

EP 3 498 102 A1 describes a chocolate product in which the polysaccharide content is to be reduced and a defined pH is to be established, and the product is then dried.

U.S. Pat. No. 4,206,245 A describes the extracting of the juice from a cacao fruit and the isolating of hydrocolloid, and the production of mixtures with nutrients, drinks or industrial products. The colloid is used as thickener and stabilizer in suspensions.

### Object

It is firstly an object of the invention to provide a product containing cacao and one or more sweeteners.

It is a further object of the invention to provide a process with which such products can be produced.

It is also an object of the invention to use such a product for producing chocolate products or chocolate analog products.

### Achievement of the Object in Relation to a Product

This object is achieved according to patent claim 1 for a product comprising cacao and one or more sweeteners, in which the sweetener or all the sweeteners are wholly or partly replaced by constituents obtained from parts of the cacao fruit, namely from the cacao fruit pulp, with or without the placenta as part of the pulp, and/or by constituents obtained from the cacao fruit shell, for sweetening and for enriching with fibrous substances.

In the product of the invention, the conventional sugar as sweetening component, according to the formulation, is replaced by a sweetening juice obtained from the cacao fruit pulp or what is called the placenta as part of the pulp, preferably a concentrate produced from this juice. Moreover, the conventional sugar component, in its function as filler, is replaced by cellulose fiber particles, likewise obtained from the cacao fruit pulp (including placenta) and/or obtained from the cacao fruit shell.

The chocolate product of the invention or the chocolate analog product of the invention contains a concentrate of cacao fruit pulp or cacao fruit pulp juice in fluid/semi-fluid form or in powder form, dispersed or suspended in cacao butter or in a fat mixture of relevance for chocolate analog products. Concentrates of this kind are produced either from cacao pulp juice or a mixture thereof with cellulose fiber components from the cacao fruit pulp and/or the inner layers of the cacao fruit shell, and partly or completely replace the sugar as sweetening component in the chocolate product in question or chocolate analog product in question.

The aforementioned cellulose fiber components from the cacao fruit pulp and/or the inner layers of the cacao fruit shell, for example in dry or moist powder form, are a natural dry food substance that replaces the sugar in accordance with the invention in chocolate products or chocolate analog products partly or even completely in terms of its crucial, conventionally utilized property as mass-affording filler/dry substance (bulking agent).

The cacao fruit shell (in botanic terms, fruit housing=pericarp) can be divided into the three different parts or layers of epicarp (outer pericarp), mesocarp (middle pericarp) and endocarp (inner pericarp).

The concentration of the substances is at its highest in the endocarp (60%), while the mesocarp has the main mass (about 50%) both of the raw fiber and the cellulose. The epicarp is the “woodiest” pericarp.

According to the invention, the two inner endocarp and mesocarp layers are utilized. These relate to about 70-95% of the dry mass of the cacao fruit shell.

### Further Inventive Configurations

According to patent claim 2, the product is characterized in that the sweetening constituent originating from the cacao fruit consists of the juice or a juice concentrate from the cacao fruit pulp.

Such a product is adjustable to a distinctly reduced calorie density compared to sugar and thus enables the production of chocolate products or chocolate analog products that have been sweetened naturally (from constituents of cacao fruit). This means that the product inventions are of particular relevance for vegan consumers. Also addressed in particular are sustainability aspects, since the additional utilization of cacao fruit shell parts firstly enables reduction in organic waste, and additional creation of value and corresponding income for cacao farmers is secondly achieved.

According to patent claim 3, the product includes added fillers obtained from the cacao fruit pulp and/or the cacao fruit shell, especially fibrous substances in the form of dry powders and/or in the form of moist powders that have swollen with incorporation of water and/or in paste form.

According to patent claim 4, the filler consists of constituents of the inner layers of the cacao fruit shell—endocarp and mesocarp.

According to patent claim 5, the product is characterized in that it is a product having a calorie density lower by 10% to 50%, corresponding to 60 to 300 kcal/100 g of product, preferably 15% to 33%, corresponding to 90 to 198 kcal/100 g of product, compared to conventional chocolate products or chocolate analog products.

The latter have an average calorie density between about 580-620 kcal/100 g (averaging about 600 kcal/100 g).

### Achievement of the Object in Relation to the Process

This object, according to patent claim 6, for production of chocolate products or chocolate analog products, is achieved in that the constituents obtained from the cacao fruit shell and/or the cacao fruit pulp for sweetening and/or enrichment with solids are introduced homogeneously into the chocolate product or chocolate analog product.

### Some Advantages

The product is promising both from the point of view of nutritional physiology and from the point of view of sustainability:

### Nutrition Aspects

By virtue of the incorporation of (i) aqueous components/concentrates from cacao powder juice in dispersed dry form, and of (ii) fiber constituents that either contribute to rheological stabilization (gel formation with development of a yield point) of the aqueous fluid droplets or else may be dispersed in the continuous fat phase as dry components or dispersed components swollen by absorption of water, it is possible to replace a crucial portion of the fat component used in conventional chocolate products and hence to distinctly reduce (>30%) calorie density.

The cacao fibers used consist of a mixture of soluble fiber components (for example pectins) and insoluble fiber components (for example cellulose) and are of high value from a nutritional point of view since they enrich anerobic product fermentation in the human colon by the production of short-chain fatty acids. A protective effect is ascribed to the latter with regard to the development of colon cancer.

In addition, it is possible to wholly or partly replace sucrose added to conventional chocolate products, since the sweetening effect of the simple sugars present in the cacao pulp have higher sweetening power than conventional sucrose. If the sweetening cacao pulp juice or concentrates produced therefrom are incorporated into the product in fluid form, i.e. pre-dissolved in water as a disperse droplet phase, accelerated dissolution of this fluid droplet phase in human saliva, associated with faster and more intense perception of product sweetness, is promoted. According to the invention, further reduction potential for added sugars is derived therefrom.

### Sustainability Aspect

The value creation chain for the cacao fruit is significantly improved by the method of the invention. Up to about 40% of the hitherto unutilized parts of the cacao fruit is utilized and returned to the food cycle. Both the fruit shells and the fruit pulp have not been used to date, and form part of food waste after harvesting. Such organic waste is generally disposed of in waste dumps, which, as a result of uncontrolled fermentation/compostation that takes place therein, is detrimental to man and the environment.

The inventive processing and use of the cacao fruit parts both improves resource efficiency and generates potential income for cacao farmers in West Africa by up to 30%.

### Further Inventive Configurations

According to patent claim 7, juice is obtained from the cacao fruit pulp and then processed further to give a concentrate and mixed homogeneously into a chocolate mass or into a chocolate analog mass.

It is particularly advantageous when, according to patent claim 8, juice is obtained from the cacao fruit pulp by means of a thermal and/or mechanical and/or enzymatic operation or treated and added homogeneously in a formulation-specific manner to the chocolate mass or chocolate analog mass.

A further advantageous procedure, according to patent claim 9, is characterized in that fibers are obtained in the form of concentrate, solids or powder from parts of the cacao fruit, namely the cacao fruit shell and/or the cacao fruit pulp, by wet comminution and subsequent drying and these are added homogeneously to the chocolate product or chocolate analog product.

According to patent claim 10, the sweetening juice concentrate is obtained from the cacao fruit pulp by means of membrane separation methods or vacuum evaporation with removal of water. This results in gentle production of the sweetening juice—obtained for example in concentrate form.

According to patent claim 11, a further procedure of the invention is characterized in that fiber powders obtained from the cacao fruit pulp or parts of the cacao fruit shell of the cacao fruit are incorporated into chocolate products or chocolate analog products by mixing these powders into preliminary cacao mass/milk powder mixtures, where the latter may also include an added proportion of sugar, and this mixture is first pre-rolled on a preliminary roll mill and then finely comminuted on a multiroll mill, especially five-roll mill or another comminution apparatus, to particle sizes ×90.3 (90% by volume percentile of the particle volume distribution) of ≤100 micrometers, preferably ≤30 micrometers, and hence what is called a main mixed phase II is produced, which, in a subsequent step, in accordance with the conventional chocolate production process, is dry conched and deagglomerated, and subjected to preliminary aroma formation.

The procedure according to patent claim 12 is characterized in that the sweetening juice concentrate obtained from the cacao fruit pulp or from powders produced therefrom by drying is first incorporated by fine dispersion in a cacao butter melt by means of dispersing apparatuses, preferably rotor/stator dispersing systems, and a W/O emulsion system is produced proceeding from concentrates, or a suspension system as what is called main mixed phase I proceeding from powders.

According to patent claim 13, a further inventive procedure is characterized in that main mixed phases I and II are combined in a second conching process step downstream of the dry conching process of main mixed phase II, and they are mixed with addition of 0.1% to 1% by weight, preferably 0.3% to 0.5% by weight, of lecithin in such a way as to achieve product homogeneity without agglomerate formation ≥100 micrometers, preferably ≥30 micrometers.

A particularly advantageous procedure is one according to patent claim 14, wherein the homogeneous complete chocolate mixture taken from the second conching process step, consisting of main mixed phases I and II, in subsequent process steps, in a comparable manner with the conventional chocolate production process, is tempered, introduced into molds or extruded and subsequently cooled, demolded and packed.

### Achievement of the Object in Relation to the Use

This object is achieved according to patent claim 15 by the use of a product of the invention, consisting of cacao components and sweeteners, where the latter have been partly or fully produced from parts of the cacao fruit, namely of the cacao fruit shell and/or of the cacao fruit pulp, and/or, in addition to their sweetening property, also result in enrichment of the chocolate product or chocolate analog product with fibrous substances.

In this way, it is not only possible to sweeten chocolate products and chocolate analog products in a formulation-specific manner with reduced calories with constituents obtained from the cacao fruit pulp but also to adjust their consistency, corresponding to shear resistance in the oral cavity, by means of fiber constituents obtained from the cacao fruit pulp (including embryo) or the cacao fruit shell.

The drawing illustrates the invention by way of example—partly in schematic form. The figures show:

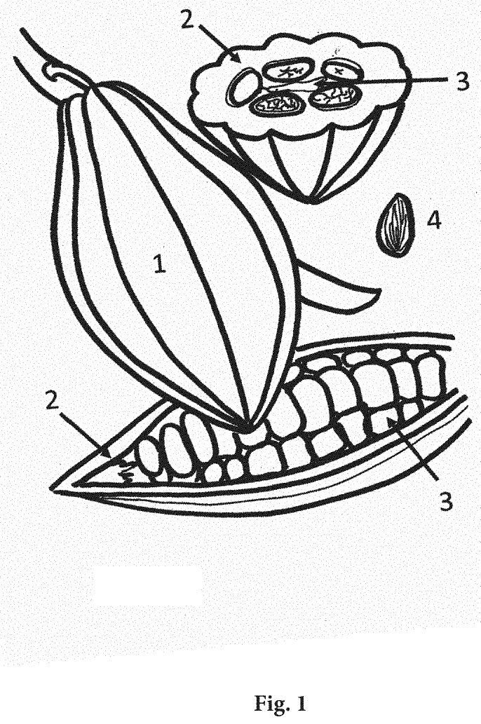

FIG. 1 a cacao fruit, partly in cross section, partly in longitudinal section;

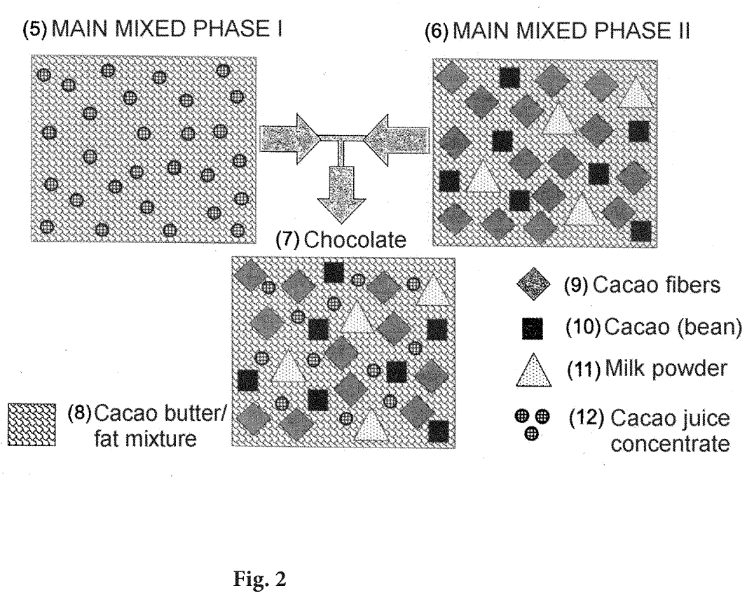

FIG. 2 components and microstructures of product subsystems referred to as main mixed phase I and main mixed phase II, which, in the overall mixture, form the structure of the chocolate or chocolate analog masses of the invention;

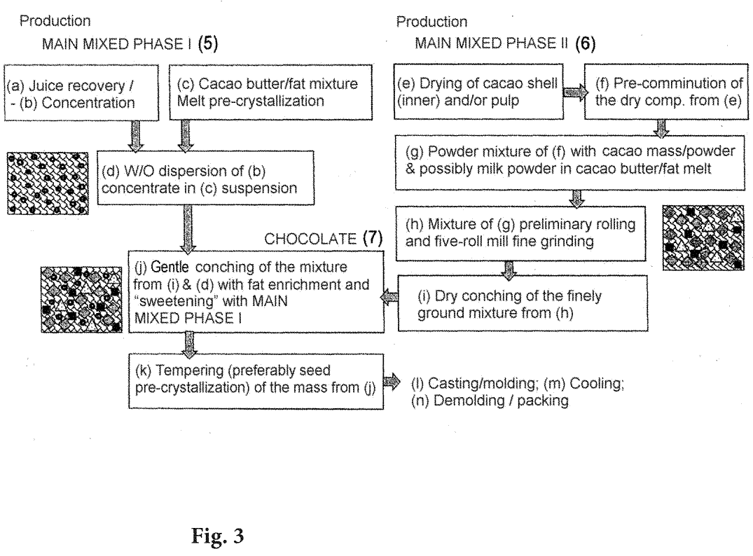

FIG. 3 schematic diagram of process steps (a-n) and resulting structure states in the production process for the chocolate/chocolate analog product systems of the invention, taking account of the separate production of the two main mixed phases I and II of the invention and the combination thereof in a gentle mixing/conching process (j) and

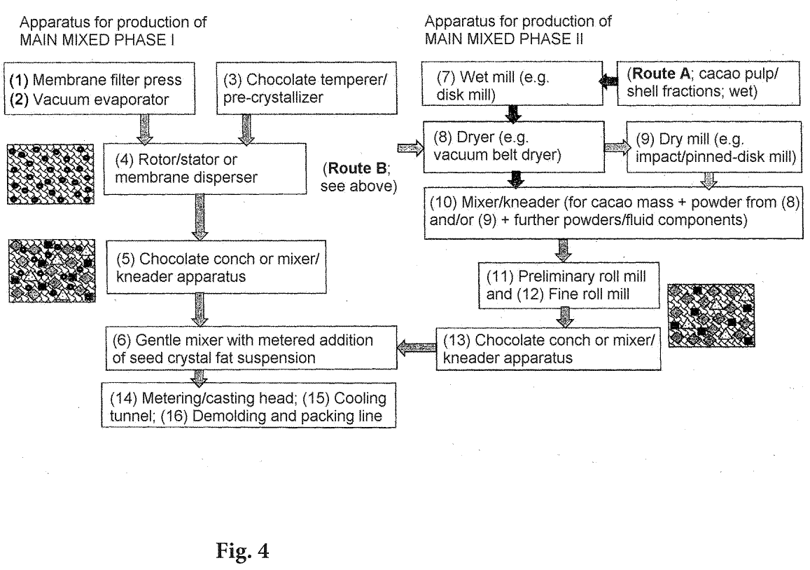

FIG. 4 an apparatus for production of a chocolate product or chocolate analog products using constituents from the cacao fruit.

The cacao fruit 1 is gherkin-shaped and about 15 to 25 cm long and 7 to 10 cm thick, surrounded by a 10 to 15 mm-thick cacao fruit shell 2, and bears, embedded in fruit pulp 3, twenty-five to fifty seeds, the cacao beans 4. Only the latter have been used to date as raw material for cacao or chocolate products or chocolate analog masses.

Fibrous materials are to be found, for example, on the inside 5 of the cacao fruit shell 2.

The chocolate product of the invention or chocolate analog product includes a concentrate of cacao fruit pulp 3 or cacao fruit pulp juice in fluid or semi-fluid form or in powder form in cacao butter or in a fat mixture of relevance to chocolate analog products. Concentrates of this kind are produced either from cacao fruit pulp juice or a mixture thereof with cellulose fiber components from the cacao fruit pulp or fibrous materials from the inside 5 of the cacao fruit shell 2, and partly or fully replace the sugar as sweetening components.

The aforementioned cellulose fiber components from the cacao fruit pulp 3 or the inside 5 of the cacao fruit shell 2 in powder form are a natural dry food suspension which can partly or even completely replace the sugar in chocolate products or chocolate analog products, even in its conventional property as bulking agent. The structure of such a chocolate product of the invention or chocolate analog product is shown in detail by FIG. 2.

The cacao fruit pulp 3 and/or portions, preferably internal portions, of the cacao fruit shell 2 are used to produce, by means of wet comminution in a wet mill, for example in a disk mill, a pasty, water-continuous, fine-particulate suspension of about ×50.3≤about 50 to 100 micrometers. This is subsequently concentrated and produced for particular rheological properties, for example zero viscosity of about 40 mPas-1 Pas and water activity (aw value) by gentle evaporation, for example vacuum evaporation, at about a maximum of 60 to 80 degrees, in the case of more liquid concentrates, or in a first concentration step, optionally also by means of membrane methods.

According to the invention, the resulting water-continuous concentrate is finely dispersed in a cocoa butter-fat mixture melt and hence a W/O emulsion structure is created. This is referred to hereinafter as sweet fruit emulsion and constitutes what is called main mixed phase I. The cocoa butter-fat mixture melt used here may optionally have been conventionally pre-crystallized/tempered or preferably converted to a pre-crystallized state with a seed crystal suspension—typically including βV and/or βVI crystals. In the process of the invention, rather than the pre-crystallized cocoa butter-fat mixture melt, this may also be used without precrystallization. For production of the main mixed phase I, preference is given to using rotor-stator dispersing apparatuses or kneading apparatuses.

Preferably, in the production process of the invention, moreover, a cacao butter/fat mixture melt with cacao mass and/or milk powder components dispersed therein, and especially powders composed of fiber constituents of the cacao fruit shell 2 and/or the cacao fruit pulp 3 (=cacao fiber powder) dispersed therein, is produced as what is called main mixed phase II.

What is called the cacao fiber powder is produced by dry comminution of sufficiently predried cacao fruit pulp 3 and/or internal cacao fruit shell fraction, for example by means of a pinned-disk mill, impact mill, ball mill or roll mill. As the case may be, a wet comminution and subsequent drying is also an option.

In a further execution of the invention, the wet-comminuted fibers, without afterdrying, can also be mixed directly into the cacao butter/fat mixture melt, which affords the particular advantage of additional water incorporation into the product via the water component absorbed into the fibers by swelling thereof.

In accordance with the process steps in the conventional chocolate production process, the mixing and comminution of the main mixed phase II is preferably effected in preliminary roll mills and five-roll mills and a downstream dry conching process step (cf. FIGS. 3 (h) and (i) and 4 (11) to (13)). In this connection, dry conching means without further fat enrichment/addition (see conventional chocolate production).

The flow properties of main mixed phase II depend on:

(A) the water content of the fibrous raw material components from cacao fruit shell 2 and/or cacao fruit pulp 3 (cf. route A (“wet method”) and route B (“dry method”) in FIGS. 4, (7) to (9)),

(B) the particle or agglomerate size distribution achieved in the roll comminution steps (cf. FIGS. 4, (11) and (12)) and the first conching process step (dry conching, cf. FIG. 4, (13)), and

(C) the cacao butter content in the cacao mass used.

The two main mixed phases I and II are preferably mixed after dry conching of main mixed phase II (see first conching process step) in a second conching process step, which is designed to be and performed in a more mechanically gentle manner than the first conching process step.

This is implemented by:

(a) reduced conching speed,

(b) increased shear gap width between rotating mixing/kneading tool and apparatus wall,

(c) “fat enrichment” and associated liquefaction of the dry-conched main mixed phase II, by the addition of the fat-rich main mixed phase I in the molten state of the fat (for example cacao butter), and by

(d) further addition of emulsifier (for example lecithin).

The resulting free-flowing product, according to the formulation and/or process-based circumstances, is tempered and either cast in shape or shaped by means of nozzles, and packed after cooling or demolding (see FIG. 3, (k) to (n); FIGS. 4 (6), (14) to (16)).

In this regard, FIG. 3 gives a detailed schematic overview of this above-described procedure.

Possible emulsifiers envisaged for the generation of the W/O emulsion for production of the main mixed phase I are, for example, lecithin (e) and/or PGPR (polyglycerol polyricinoleate) with a proportion by mass of about 0.1% to 1% by volume, preferably 0.3-0.5%, in the cacao butter/fat mixture (O phase).

In a further-developed embodiment of the process of the invention, an O1/W/O2 emulsion is generated, wherein polyunsaturated oils with cacao antioxidants (for example flavanols: catechin epicatechin) dissolved/dispersed therein and fat-soluble vitamins are optionally added to the inner oil phase (O1).

In the second conching process, as a measure of gentle treatment in the mixing of the main mixed phases I and II, the homogeneity of the structure of the resulting mixture formed from main mixed phases I and II is used. In the event of mechanical overstress of the main mixed phase I and II mixed system structure, for example, increased interaction of the dispersed fruit juice concentrate droplets from main mixed phase I with comminuted fiber particles from main mixed phase II is to be expected, which can lead to formation of relatively large agglomerates. If such agglomerate diameters remain less than about 100 micrometers, preferably less than 30 micrometers, the second conching process step is considered to be sufficiently gentle. In terms of flow mechanistic detail, this means that exceedance of critical shear stress limits has been avoided, which would lead to an unwanted change in the resulting chocolate structure as a result of agglomerate formation from particulate solid constituents and the juice/concentrate emulsion droplets.

The features described in the patent claims and in the description and apparent from the drawing may each be essential to the implementation of the invention individually or in any combinations.

1. A product comprising cacao and one or more sweeteners, in which the sweetener or all the sweeteners are wholly or partly replaced by constituents obtained from parts of the cacao fruit, namely from the cacao fruit pulp, with or without the placenta as part of the pulp, and/or by constituents obtained from the cacao fruit shell, for sweetening and for enriching with fibrous substances.

2. The product according to claim 1, wherein the sweetening constituent originating from the cacao fruit consists of the juice or a juice concentrate from the cacao fruit pulp.

3. The product according to claim 1, wherein the product includes added fillers obtained from the cacao fruit pulp (3) and/or the cacao fruit shell, especially fibrous substances in the form of dry powders and/or in the form of moist powders that have swollen with incorporation of water and/or in paste form.

4. The product according to claim 3, wherein the filler consists of constituents of the inner layers of the cacao fruit shell endocarp and mesocarp.

5. The product according to claim 1, wherein it is a product having a calorie density lower by 10% to 50%, corresponding to 60 to 300 kcal/100 g of product, preferably 15% to 33%, corresponding to 90 to 198 kcal/100 g of product, compared to conventional chocolate products or chocolate analog products.

6. A process for producing chocolate products or chocolate analog products, in which the constituents obtained from the cacao fruit shell and/or the cacao fruit pulp for sweetening and/or enrichment with solids are introduced homogeneously into the chocolate product or chocolate analog product.

7. The process according to claim 6, wherein juice is obtained from the cacao fruit pulp and then processed further to give a concentrate and mixed homogeneously into a chocolate mass or a chocolate analog mass.

8. The process according to claim 7, wherein juice is obtained from the cacao fruit pulp by means of a thermal and/or mechanical and/or enzymatic operation or treated and added homogeneously in a formulation-specific manner to the chocolate mass or chocolate analog mass.

9. The process according to claim 6, wherein fibers are obtained in the form of concentrate, solids or powder from parts of the cacao fruit, namely the cacao fruit shell and/or the cacao fruit pulp, by wet comminution and subsequent drying and these are added homogeneously to the chocolate product or chocolate analog product.

10. The process according to claim 7, wherein the sweetening juice concentrate is obtained from the cacao fruit pulp by means of membrane separation methods or vacuum evaporation with removal of water.

11. The process according to claim 6, wherein fiber powders obtained from the cacao fruit pulp or parts of the cacao fruit shell of the cacao fruit are incorporated into chocolate products or chocolate analog products by mixing these powders into preliminary cacao mass/milk powder mixtures, where the latter may also include an added proportion of sugar, and this mixture is first pre-rolled on a preliminary roll mill and then finely comminuted on a multi-roll mill, especially five-roll mill or another comminution apparatus, to particle sizes ×90.3 (90% by volume percentile of the particle volume distribution) of ≤100 micrometers, preferably ≤30 micrometers, and hence what is called a main mixed phase II is produced, which, in a subsequent step, in accordance with the conventional chocolate production process, is dry conched and deagglomerated, and subjected to preliminary aroma formation.

12. The process according to claim 6, wherein the sweetening juice concentrate obtained from the cacao fruit pulp or from powders produced therefrom by drying is first incorporated by fine dispersion in a cacao butter melt by means of dispersing apparatuses, preferably rotor/stator dispersing systems, and a W/O emulsion is produced proceeding from concentrates, or a suspension system as what is called main mixed phase I proceeding from powders.

13. The process according to claim 11, wherein main mixed phases I and II are combined in a second conching process step downstream of the dry coating process of main mixed phase II, and they are mixed with addition of 0.1% to 1% by weight, preferably 0.3% to 0.5% by weight, of lecithin in such a way as to achieve product homogeneity without agglomerate formation ≥100 micrometers, preferably ≥30 micrometers.

14. The process according to claim 13, wherein the homogeneous complete chocolate mixture taken from the second conching process step, consisting of main mixed phases I and II, in subsequent process steps, in a comparable manner with the conventional chocolate production process, is tempered, introduced into molds or extruded and subsequently cooled, demolded and packed.

15. The use of a product as chocolate product or chocolate analog product according to claim, consisting of cacao components and sweeteners, where the latter have been partly or fully produced from parts of the cacao fruit, namely of the cacao fruit shell and/or of the cacao fruit pulp, and/or, in addition to their sweetening property, also result in enrichment of the chocolate product or chocolate analog product with fibrous substances.
